(19) United States
(12) Patent Application Publication
(10) Pub. No.: US 2023/0084715 A1
(43) Pub. Date: Mar. 16, 2023

(54) UTILIZING AID TO SET A STATION MAC ADDRESS IN A WLAN SYSTEM

(71) Applicant: ARRIS Enterprises LLC, Suwanee, GA (US)

(72) Inventors: Kurt LUMBATIS, Dacula, GA (US); Mark HAMILTON, Superior, CO (US)

(21) Appl. No.: 17/902,281

(22) Filed: Sep. 2, 2022

Related U.S. Application Data
(60) Provisional application No. 63/244,344, filed on Sep. 15, 2021.

(51) Int. Cl. H04W 12/69; H04W 12/041; H04W 12/02

(52) U.S. Cl. CPC H04W 12/69; H04W 12/041; H04W 12/02

(57) ABSTRACT

To protect and ensure security and/or privacy, an access point and a wireless network device can exchange capabilities information. The capabilities information can indicate that each of the access point and the wireless network device support generation of an association identifier association media access control (A-AMAC) identifier. The A-AMAC identifier is based on an association identifier (AID) (that is assigned by the access point and associated with the wireless network device) and any other information exchanged between the access point and the wireless network device. The A-AMAC identifier once generated can be stored by the access point. The A-AMAC identifier is then used for post association communications between the access point and the wireless network device. As the A-AMAC identifier is a unique identifier for the association of the access point and the wireless network device, tracking of the wireless network device is thwarted or inhibited.

### BACKGROUND

Wireless network devices (e.g., WLAN (wireless local area network) or Wi-Fi devices) are increasingly adopting randomized MAC (media access control) addresses. This poses a problem for many parts of the WLAN infrastructure of a WLAN environment that may use a MAC address of a wireless network device as a unique identifier for the wireless network device. For example, a user may expect a certain level of privacy, such as related to tracking of a particular wireless network device.

Generally, in a WLAN environment, MAC addresses are transmitted unencrypted. Such transmission makes it easy to track any wireless network device connected to the network of the WLAN environment, especially if a wireless network device is constant or even constant across associations within a given WLAN environment. Even using a randomized MAC address in certain frames and a ‘real’ MAC address when associated to a known network still allows for a wireless network device to become known or tracked. Thus, there is a need to provide an identifier for a wireless network device that is only utilized within a basic service set (BSS)/extended service set (ESS) to which the wireless network device is associating but cannot be tracked.

### SUMMARY OF THE INVENTION

In an Institute of Electrical and Electronics Engineers (IEEE) 802.11 standard WLAN system, MAC addresses are always sent unencrypted. As such, this information is subject to tracking, such as by an external entity (for example, a malicious malware or nefarious organization, person, or group) or any other device connected to the network. Governmental entities are enacting privacy laws, private entities or organizations are requiring increased security to protect user privacy, and individual users or consumers or expecting an increased level of protection of private or personal information. These increased security or privacy requirements require that no identifiable information be sent that can be used to track any individual wireless network device. To maintain the wireless network environment viability, an identifier needs to be securely assigned to a wireless network device (such as a station (STA), any other access point (AP), a client device (a non-AP STA), or a wireless extender/wireless extender access point) at the time of association. Typically, these assigned identifiers, however, are still trackable as the MAC address remains the same for the wireless network device across multiple networks or associations. For example, the MAC address which is transmitted in the clear may remain the same for a known network as the wireless network device associates with multiple wireless network devices in the network. As another example, in a hotspot network, if a wireless network device has utilized MAC randomization such that the same MAC address is used within a given service set identifier (SSID), the wireless network device can be tracked as it moves across differing access points within the hotspot network. The present invention provides for the generation of an association identifier association media access control (A-AMAC) identifier for a wireless network device and an access point to use during communication between the two devices. This A-AMAC identifier remains unique within a given association and thus cannot be tracked once the wireless network device is directed to a different association as a different A-AMAC identifier will be generated based on the different association. The invention generates a unique A-AMAC identifier for a wireless network device that is unique for a given access point and only used based on an association identifier (AID) assigned to the wireless network device at association time and information that is shared between the wireless network device and the access point.

An aspect of the present disclosure provides a method for an access point to generate an association identifier association media access control (A-AMAC) identifier for communicating with a wireless network device. The method comprises receiving one or more capabilities from the wireless network device, determining that the wireless network device supports A-AMAC identifier functionality based on the one or more capabilities, generating the A-AMAC identifier based on an association identifier (AID) that is assigned by the access point when the wireless network device associates with the access point, and sending an association response frame to the wireless network device, wherein the association response frame comprises an AID field that indicates to the wireless network device to generate the A-AMAC identifier based on the AID.

In an aspect of the present disclosure, the method is such that the A-AMAC identifier is based on a basic service set identifier (BSSID) of the access point.

In an aspect of the present disclosure, the method is such that the A-AMAC identifier comprises three bytes associated with a lower three bytes of the BSSID, two bytes associated with the AID, and a byte associated with the BSSID with a locally administered address bit set to true.

In an aspect of the present disclosure, the method is such that a two most significant bits of the AID field of the association response frame indicate to the wireless network device to generate and use the A-AMAC identifier based on the AID and the BSSID.

In an aspect of the present disclosure, the method further comprises communicating with the wireless network device using the A-AMAC identifier post association.

In an aspect of the present disclosure, the method further comprises generating a pairwise master key (PMK) for a robust security network (RSN) association.

In an aspect of the present disclosure, the method further comprises storing the A-AMAC identifier in an association database of the access point, wherein the A-AMAC identifier is associated with the wireless network device in the association database.

An aspect of the present disclosure provides an access point for generating an association identifier association media access control (A-AMAC) identifier for communicating with a wireless network device. The access point comprises a memory storing one or more computer-readable instructions and a processor. The processor is configured to execute the one or more computer-readable instructions to perform one or more operations to receive one or more capabilities from the wireless network device, determine that the wireless network device supports A-AMAC identifier functionality based on the one or more capabilities, generate the A-AMAC identifier based on an association identifier (AID) that is assigned by the access point when the wireless network device associates with the access point, and end an association response frame to the wireless network device, wherein the association response frame comprises an AID field that indicates to the wireless network device to generate the A-AMAC identifier based on the AID.

In an aspect of the present disclosure, the A-AMAC identifier is based on a basic service set identifier (BSSID) of the access point.

In as aspect of the present disclosure, the A-AMAC identifier comprises three bytes associated with a lower three bytes of the BSSID, two bytes associated with the AID, and a byte associated with the BSSID with a locally administered address bit set.

In an aspect of the present disclosure, a two most significant bits of the AID field of the association response frame indicate to the wireless network device to generate and use the A-AMAC identifier based on the AID and the BSSID.

In an aspect of the present disclosure, the processor is further configured to execute the one or more computer-readable instructions to further perform one or more further operations to communicate with the wireless network device using the A-AMAC identifier post association.

In an aspect of the present disclosure, the processor is further configured to execute the one or more computer-readable instructions to perform one or more further operations to generate a pairwise master key (PMK) for a robust security network (RSN) association.

In an aspect of the present disclosure, the processor is further configured to execute the one or more computer-readable instructions to perform one or more further operations to store the A-AMAC identifier in an association database of the access point, wherein the A-AMAC identifier is associated with the wireless network device in the association database.

An aspect of the present disclosure provides a non-transitory computer-readable medium of an access point storing one or more computer-readable instructions for generating an association identifier association media access control (A-AMAC) identifier for communication with a wireless network device, the one or more computer-readable instructions when executed by a processor of the access point, cause the access point to perform one or more operations of any one or more of the above method steps.

An aspect of the present disclosure provides a method for a wireless network device to generate an association identifier association media access control (A-AMAC) identifier for communicating with an access point. The method comprises exchanging one or more capabilities with the access point, wherein the one or more capabilities indicate support for A-AMAC identifier functionality, receiving an association response frame from the access point, wherein the association response frame comprises an AID field that indicates to the wireless network device to generate the A-AMAC identifier based on an association identifier (AID) that is assigned by the access point when the wireless network device associates with the access point, and generating the A-AMAC identifier based on the AID.

In an aspect of the present disclosure, the method is such that the A-AMAC identifier is based on a basic service set identifier (BSSID) of the access point.

In an aspect of the present disclosure, the method further comprises communicating with the access point using the A-AMAC identifier post association.

In an aspect of the present disclosure, the method further comprises associating with the access point, wherein the AID is received as part of the association and wherein receiving the association response frame comprises re-associating with the access point.

In an aspect of the present disclosure, the method is such that a two most significant bits of the AID field of the association response frame indicate to the wireless network device to generate the A-AMAC identifier based on the AID.

In an aspect of the present disclosure, the method further comprises storing the A-AMAC identifier in a memory of the wireless network device.

An aspect of the present disclosure wireless network device for generating an association identifier association media access control (A-AMAC) identifier for communicating with an access point. The wireless network device comprises a memory storing one or more computer-readable instructions and a processor. The processor is configured to execute the one or more computer-readable instructions to perform one or more operations exchange one or more capabilities with the access point, wherein the one or more capabilities indicate support for A-AMAC identifier functionality, receive an association response frame from the access point, wherein the association response frame comprises an AID field that indicates to the wireless network device to generate the A-AMAC identifier based on an association identifier (AID) that is assigned by the access point when the wireless network device associates with the access point, and generate the A-AMAC identifier based on the AID.

In an aspect of the present disclosure, the A-AMAC identifier is based on a basic service set identifier (BSSID) of the access point.

In as aspect of the present disclosure, the A-AMAC identifier comprises three bytes associated with a lower three bytes of the BSSID, two bytes associated with the AID, and a byte associated with the BSSID with a locally administered address bit set.

In an aspect of the present disclosure, the processor is further configured to execute the one or more computer-readable instructions to perform one or more further operations to communicate with the access point using the A-AMAC identifier post association.

In an aspect of the present disclosure, the processor is further configured to execute the one or more computer-readable instructions to perform one or more further operations to associate with the access point, wherein the AID is received as part of the association and wherein receiving the association response frame comprises (re)associating with the access point.

In an aspect of the present disclosure, a two most significant bits of the AID field of the association response frame indicate to the wireless network device to generate the A-AMAC identifier based on the AID.

In an aspect of the present disclosure, the processor is further configured to execute the one or more computer-readable instructions to perform one or more further operations to store the A-AMAC identifier in a memory of the wireless network device.

An aspect of the present disclosure provides a non-transitory computer-readable medium of a wireless network device storing one or more computer-readable instructions for generating an association identifier association media access control (A-AMAC) identifier for communicating with an access point, the one or more computer-readable instructions when executed by a processor of the wireless network device, cause the wireless network device to perform one or more operations of any one or more of the above method steps.

### BRIEF DESCRIPTION OF THE DRAWINGS

FIG. 1 is a block diagram illustrating an example network environment operable to facilitate generation of an association identifier association media access control (A-AMAC) identifier for a wireless network device, according to one or more aspects of the present disclosure.

FIG. 2 shows an example format for a capability information field that includes an A-AMAC capability or functionality setting, according to one or more aspects of the present disclosure.

FIGS. 3A and 3B show an example format for an A-AMAC identifier, according to one or more aspects of the present disclosure.

FIG. 4 is a block diagram illustrating an example access point operable to facilitate generation of an A-AMAC identifier by an access point and a station, according to one or more aspects of the present disclosure.

FIG. 5 is a flowchart illustrating an example process operable to facilitate generation of an A-AMAC identifier, according to one or more aspects of the present disclosure.

FIG. 6 is a block diagram of a hardware configuration operable to facilitate generation of an A-AMAC identifier, according to one or more aspects of the present disclosure.

FIG. 7 is a flowchart illustrating an example process operable to facilitate an access point generating an A-AMAC identifier and exchanging capabilities information with a station, according to one or more aspects of the present disclosure.

FIG. 8 is a flowchart illustrating an example process operable to facilitate a wireless network device generating an A-AMAC identifier and exchanging capabilities information with an access point, according to one or more aspects of the present disclosure.

Like reference numbers and designations in the various drawings indicate like elements.

### DETAILED DESCRIPTION

It is desirable to improve upon methods and systems for handling unique identifiers for wireless network devices (such as stations) so as to ensure privacy and security for the wireless network device, for example, to thwart tracking of the wireless network device for malicious or nefarious purposes. Methods, systems, and computer readable media can be operable to facilitate the generation of a unique identifier that comprises an association media access control (AMAC) based on an association identifier (AID), referred to herein as an A-AMAC identifier, for use in communications between an access point and a wireless network device so as to an improved secure and private connection for the communications. The access point and the wireless network device can exchange capabilities information (as part of an association request/association response signaling between the wireless network device and the access point) that indicates support for A-AMAC functionality such that the access point and the wireless network device can each generate an A-AMAC identifier for use in communications based on a pre-determined or known method or process. Exchanging capabilities allows the access point and the wireless network device to remain compatible with devices that do not support generating and using an A-AMAC identifier.

Described herein is a use of a reserved bit in a capability information field of the IEEE 802.11 standard that indicates that an A-AMAC identifier should be generated and used for communications between an access point and a wireless network device. Once it is determined that both an access point and wireless network device support the A-AMAC functionality, the access point signals the wireless network device in the association response frame (for example, a re-association response frame) that the AID should be utilized to set the AMAC. The reserved bit of the capability information field, for example, the third most significant bit in the capability information field, can be set so as to indicate that an A-AMAC identifier should be generated by both the access point and the wireless network device and used for all subsequent communications between the access point and the wireless network device.

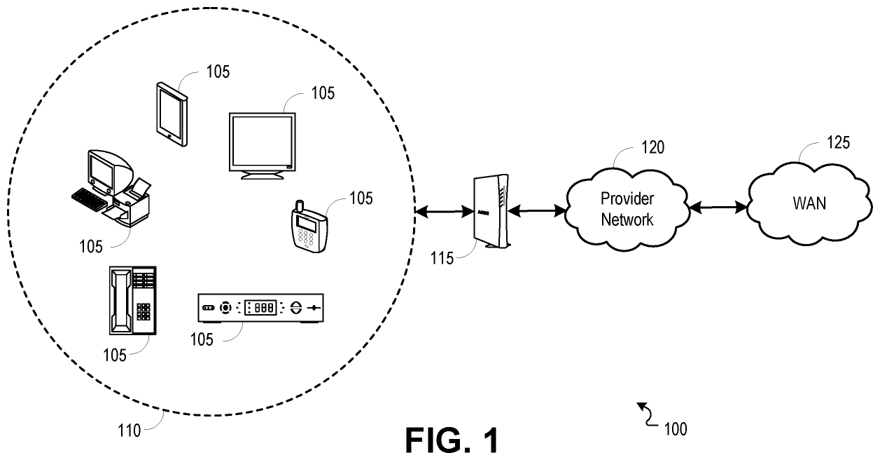

FIG. 1 is a block diagram illustrating an example network environment 100 operable to facilitate generation of an A-AMAC identifier for use in communications between an access point and a wireless network device. In one or more embodiments, video, voice, and/or data services may be delivered to one or more wireless network devices 105 over one or more signal paths. The wireless network devices 105 may include a laptop, mobile device, tablet, computer, set-top box (STB), gaming device, wearable device, and any other device operable to receive video, voice, and/or data services via wireless network connection. It should be understood that various data, multimedia, and/or voice services may be delivered to the stations 105, including but not limited to streaming video, streaming audio, file transfer, email, telephony services, and others.

Multiple services may be delivered to stations 105 over one or more local wireless networks 110. The local wireless network(s) 110 may include a wireless local area network (WLAN), personal area network (PAN), mobile hotspot network, and others. The local network 110 may be provided at a subscriber premise by one or more access points 115. An access point 115 may be, for example, a CPE (customer premise equipment) device and may include any device configured to facilitate communications between a Wide Area Network (WAN) and one or more stations 105, such as a modem, multimedia terminal adapter (MTA), embedded MTA (EMTA), gateway device, network extender, or other access device. An access point 115 may be integrated with other devices. For example, an access point 115 may include a broadband access modem (for example, a modem may reside within a gateway device, STB, or other devices). It should be understood that delivery of the multiple services over the local network(s) 110 may be accomplished using a variety of standards and formats. It will be appreciated by those skilled in the relevant art that stations 105 may be capable of interacting and communicating with each other and/or with an access point 115 over various wireless communication standards (for example, Wi-Fi, Bluetooth, etc.).

In one or more embodiments, an access point 115 may be connected to a broadband access network 120 and may route communications between one or more stations 105 and a WAN (wide-area network) 125 through the connection to the broadband access network 120. Note that the broadband access network may itself be wired or wireless.

In general, and according to wireless communication standards, a station 105 will constantly probe for a new network if the station 105 is not currently connected. Typically, the probe messages contain, among other fields, a MAC (media access control) address for the station 105. A coordinated network may track movements of an end user by tracking the probe messages received at different access points if the network has knowledge of the MAC address of the end user's device as the MAC addresses are transmitted unencrypted.

To offer additional privacy to an end user, MAC randomization may be utilized. Randomized MAC addresses may be facilitated by using MAC addresses from the local MAC address space. A local MAC address can be identified if a “local” bit is set (e.g., second bit of the first byte of the MAC address). Use of a local MAC address space minimizes the chance of a device choosing a MAC address that might already be in use by another device. Use of this MAC address space also suggests to a receiving device (e.g., access point) that it has received a randomized MAC (rMAC) address which may influence actions that it takes with respect to that station. Such MAC randomization, though, can still have issues with maintaining the privacy or security of a particular station 105. For example, one issue is that in hotspot networks if a station 105 has implemented this MAC randomization such that the station 105 retains the same MAC address within a given SSID, then the station 105 can be tracked as it moves across differing access point within the hotspot network. To address such security and privacy issues, the utilized MAC address can be unique to a given access point 115 for a given station 105 and only used based on the AID assigned to the station 105 at association time and other shared information between the station 105 and the access point 115.

To allow flexibility, a secured communication exchange (for example, action frame exchange) is defined herein to allow an access point 115 and a station 105 to exchange one or more capabilities related to generation of an A-AMAC identifier. For example, the communication exchange can include a capabilities exchange, that is passed as part of a capabilities information element or as part of an extended capabilities element, from the access point 115 and received by a station 105, and a capabilities response that is transmitted from the station 105, to the access point 115, in response to capabilities exchange. The capabilities exchange and capabilities response messages may be wireless communications (for example, 802.11 messages). The capabilities response can include a capability information field that has one or more dedicated bits that indicate the device, such as station 105, supports generation of an A-AMAC unique identifier.

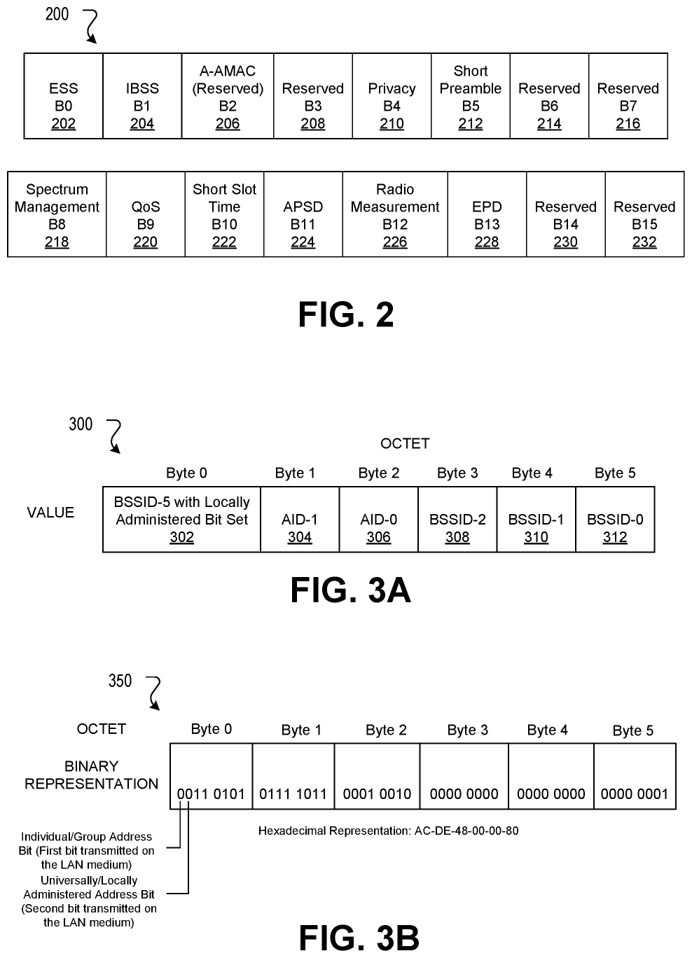

The access point 115 can determine based on the capabilities response (for example, the capability information field of FIG. 2) from the station 105 that the station 105 supports generation of an A-AMAC identifier. The access point 115 can signal or communicate to the station 105 in an association response frame that the A-AMAC identifier (the unique identifier for the station 105 for use in communications with the particular access point 115) is based on the AID. The access point 115 and the station 105 can determine or generate the A-AMAC identifier based on a known or pre-determined algorithm. As the A-AMAC identifier is only used for communications between a particular access point 115 and a particular station 105, the station 105 is not trackable when the station 105 changes locations and associates with different access points 115.

FIG. 2 shows an example format for a format for a capability information field 200 that includes an A-AMAC capability or functionality setting, according to one or more aspects of the present disclosure. The capability information field 200 includes sixteen bits as identified in the IEEE 802.11 standard. The most significant bit 202 is identified as Bit 0 (B0) of the capability information field and is associated with an ESS. The next bit 204 is identified as Bit 1 (B1) of the capability information field and is associated with an independent basic service set (IBSS). Bits 206, 208, 214, 216, 230 and 232 identified as Bit 2 (B2), Bit 3 (B3), Bits 6 (B6), Bit 7 (B7), Bit 14 (B14) and Bit 15 (B15) of the capability information field, respectively, are reserved bits. Bit 210 identified as Bit 4 (B4) of the capability information field is associated with a privacy setting. Bit 212 is identified as Bit 5 (B5) of the capability information field and is associated with a short preamble. Bit 218 is identified as Bit 8 (B8) of the capability information field and is associated with spectrum management. Bit 220 is identified as Bit 9 (B9) of the capability information field and is associated with quality of service (QoS). Bit 222 is identified as Bit 10 (B10) of the capability information field and is associated with a short slot time. Bit 224 is identified as Bit 11 (B11) of the capability information field and is associated with automatic power save delivery (APSD). Bit 226 is identified as Bit 12 (B12) of the capability information field and is associated with radio measurement. Bit 228 is identified as Bit 13 (B13) of the capability information field and is associated with ethertype protocol discrimination (EPD).

Any one or more of the reserved bits 206, 208, 214, 216, 230, and 232 can be utilized as an A-AMAC capability or functionality setting so as to indicate that a wireless network device, such as station 105, supports A-AMAC identifier functionality. For example, bit 206 can be used as an A-AMAC setting such that a station 105 sets the bit 206 (such as to a binary 1) in response to a capabilities exchange from an access point 115 to indicate that the station 105 supports A-AMAC identifier functionality. An access point 115 can determine that a station 105 can generate an A-AMAC identifier based on the Bit 206 of the capability information field 200 that is transmitted by the station 105 in response to a capabilities exchange from the access point 115.

FIG. 3A shows an example format for an A-AMAC identifier 300, according to one or more aspects of the present disclosure. In one or more embodiments, the access point 115 and the station 105 can generate a A-AMAC identifier 300 based on any one or more pre-determined or known algorithms or methods. As an example, the A-AMAC identifier 300 can comprise six octets or six eight bit bytes as indicated in FIG. 3. The first or most significant byte 302 is identified as Byte 0 and is associated with a fifth byte of a basic service set identifier (BSSID-5) with a locally administered address bit set to true. The second byte 304 is identified as Byte 1 of the A-AMAC identifier and is associated with a second byte of the AID (AID-1). The third byte 305 is identified as Byte 2 of the A-AMAC identifier and is associated with a first byte of the AID (AID-0). The fourth byte is identified as Byte 3 of the A-AMAC identifier and is associated with a third byte of the BSSID (BSSID-2). The fifth byte 310 is identified as Byte 4 of the A-AMAC identifier and is associated with a second byte of the BSSID (BSSID-1). The sixth or least significant byte 312 is identified as Byte 5 of the A-AMAC identifier and is associated with a first byte of the BSSID (BSSID-0). In one or more embodiments, any one or more of 302, 304, 306, 308, 310 and 312 can be arranged in any order. The A-AMAC identifier 300 can be used by the access point 115 and the station 105 for all post association communications between the access point 115 and the station 105.

While FIG. 3A illustrates an example A-AMAC identifier, the present disclosure contemplates that the A-AMAC identifier can be generated using the AID (assigned by the access point) and any other information exchanged between the access point 115 and the station 105. Additionally, while FIG. 3 illustrates a six byte or octet A-AMAC identifier, the present disclosure contemplates that any number of bytes sufficient to uniquely identify the station 105 to the access point 115 can be used.

FIG. 3B shows an example format for an A-AMAC identifier 350 that is similar to or the same as FIG. 3A except that FIG. 3B includes exemplary values for the octets, according to one or more aspects of the present disclosure. Byte 0 of FIG. 3B (the first octet) comprises the first two bits set to a binary 0 followed by binary 110101. The first bit represents an individual/group address bit (set to true or a binary 0) and is the first bit transmitted on a LAN medium. The second bit represents a universally/locally administered address bit (set to true or a binary 0) and is the second bit transmitted on the LAN medium. The value represented by the A-AMAC identifier 350 can also be represented in hexadecimal or base 16 number system, for example, as 0xAC DE 48 00 00 80.

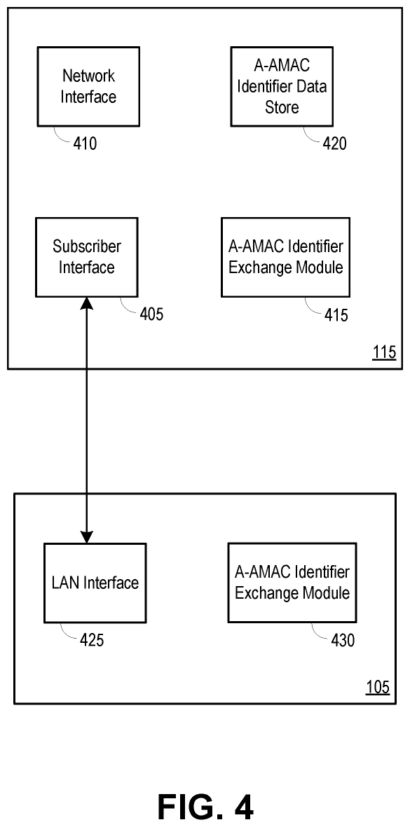

FIG. 4 is a block diagram illustrating an example access point 115 operable to facilitate generation of an A-AMAC identifier 300 by the access point 115 and a station 105, according to one or more aspects of the present disclosure. The access point 115 may include a subscriber interface 405, a network interface 410, an A-AMAC identifier exchange module 415, and an A-AMAC identifier data store 420. The station 105 may include a LAN interface 425 and an A-AMAC identifier exchange module 430.

In one or more embodiments, wireless communications can be output to and/or received from one or more stations 105 through a subscriber interface 405 of the access point 115. Wireless communications or messages can comprise data, video, and/or voice data or packets. It should be understood that the subscriber interface 405 may be configured to receive and/or output wireless communications using various communication techniques, protocols, and standards (for example, Wi-Fi). In one or more embodiments, wireless communications or messages may be output to and/or received from one or more upstream networks (for example, broadband access network 120 of FIG. 1, WAN 125 of FIG. 1, etc.) through the network interface 410.

In one or more embodiments, the A-AMAC identifier exchange module 415 may generate and output one or more messages directed to a station 105, such as a capabilities exchange. The A-AMAC identifier exchange module 415 may receive one or more response messages from station 105 such as a capabilities response. Based on the exchange of capabilities, the A-AMAC identifier exchange module 415 and the A-AMAC identifier exchange module 430 can generate an A-AMAC identifier 300 for use in any post association communications between the access point 115 and the station 106. The A AMAC identifier exchange module 415 can store the A-AMAC identifier associated with the station 105 in an A-AMAC identifier data store 420 or any other memory or repository. In one or more embodiments, the A-AMAC identifier can be stored at a network resource remote from the access point 115.

The unique identifier exchange module 415 may facilitate the use of A-AMAC identifiers for one or more stations 105 to prevent or inhibit tracking of the one or more stations 105 within a network. For example, a station 105 may transmit wireless communications to and receive wireless communications from an access point 115 through the LAN interface 425 using the A-AMAC identifier generated at each of the access point 115 and the station 105 uniquely for communications between the access point 115 and the station 105 such that no other device on the network can identify the station 105.

The unique identifier exchange module 430 can receive a capabilities exchange messages from the access point 115 and generate a response message. In one or more embodiments, the unique identifier exchange module 430 may retrieve and/or generate an A-AMAC identifier for the station 105 based on the AID and any other information exchanged between the access point 115 and the station 105 for use in identifying the station 105 in wireless communications between the access point 115 and the station 105.

While FIG. 4 illustrates a station as a wireless network device 105, the present disclosure contemplates any type of wireless network device 105 that supports A-AMAC identifier generation.

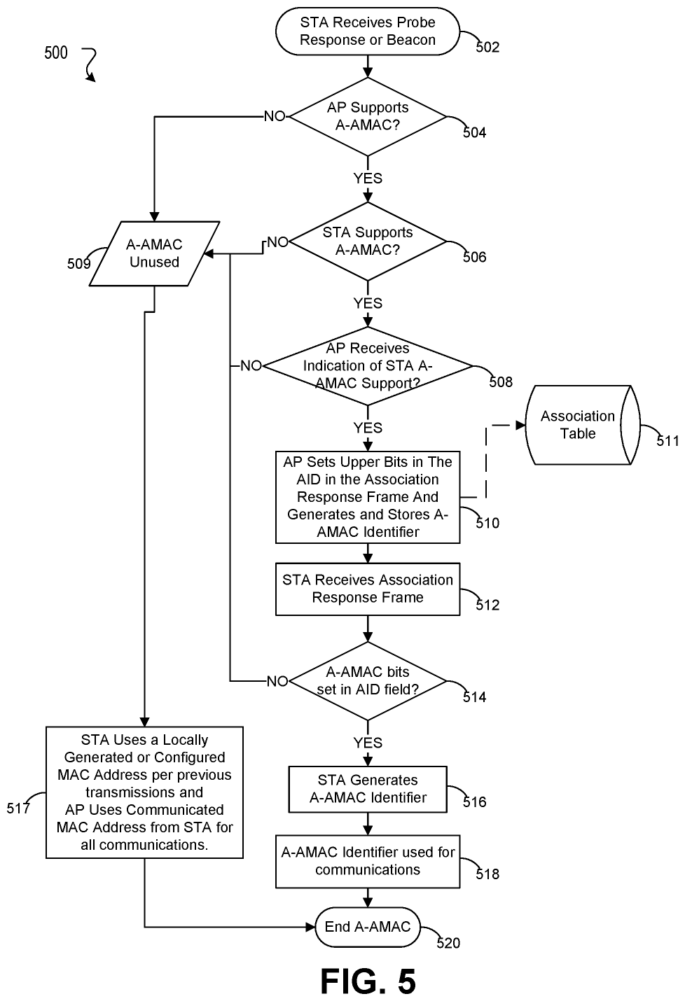

FIG. 5 is a flowchart illustrating an example process operable to facilitate generation of an A-AMAC identifier, according to one or more aspects of the present disclosure. The process 500 can begin after a station (for example, station 105 of FIG. 1) begins association with an access point (for example, access point 115 of FIG. 1). The process 500 can begin at 502, when a probe request is sent from the station or beacon is receive by the station from the access point. The access point assigns an AID to the station in response to an association request frame and can send a capabilities exchange to the station in the association response. The station can receive the probe response or beacon, including a capabilities exchange, and can send a response message to the access point that includes a capability information field (for example, capability information field 200 of FIG. 2) that comprises an A-AMAC setting or indication. The station can also receive a capability information field that comprises an A-AMAC setting in a message or communication from the access point.

At step 504, the station determines whether the access point supports A-AMAC identifier functionality (the generation of an A-AMAC identifier) based on the capability information field received from the access point. If the access point does not support A-AMAC functionality, the process continues to step 509 where the A-AMAC bit of the capability information field is not used and at step 517 the station uses a locally generated or configured MAC address per previous transmissions. If the access point does support A-AMAC functionality, the process continues to step 506 where the access point determines whether the station supports A-AMAC functionality based on the capability information field received from the station. If the station does not support A-AMAC functionality, the process continues to step 509 where the A-AMAC bit of the capability information field is not used and at to step 517 the access point uses a communicated MAC address from the station for all communications. In one or more embodiments, steps 506 and 508 are performed simultaneously or substantially simultaneous with each other.

If both the station and the access point support A-AMAC functionality as determined at steps 506 and 508, the process continues to step 510. At step 510, the access point sets one or more upper or significant bits of the AID in the association response frame so as to indicate that the unique identifier for the access station is an A-AMAC identifier. The access point generates the A-AMAC identifier based on the AID and other information shared between the access point and the station and/or one or more pre-determined algorithms or methods known to the access point and the station, for example, as discussed with reference to FIG. 3. At step 511, the access point can store the A-AMAC identifier in an association table, for example, an A-AMAC identifier data store 420 as discussed with reference to FIG. 4.

At step 512, the process continues with the station receiving from the access point an association response frame that includes the AID with one or more of the upper or most significant bits of the AID (referred to as one or more A-AMAC bits) set so as to indicate that generation of the A-AMAC identifier is based on the AID. At step 514, the station determines that the one or more A-AMAC bits are set. For example, the two most significant bits of the AID can be used to signal to a station to use the AID to generate the A-AMAC identifier, such as setting the two most significant to a binary 1 and a binary 0 (or 0x80 hexadecimal or base 16 number system). Setting the one or more A-AMAC bits allows the access point and station to function with non-A-AMAC supported devices. For example, setting the A-AMAC bits (such as the two most significant bits of the AID) to binary 10 will provide compatibility legacy systems, such as with sub 1 Gigahertz (S1G) devices and/or directional multi-gigabit (DMG) beacons. For non-DMG stations, the two most significant bits of the AID are set to a binary 11 so by setting these bits to a binary 10 (such as 10xx xxx xxxx binary, where “10” are the two most significant bits and “x” represents any value of a binary “1” or a binary “0”) for a station that support A-AMAC identifier generation the station is signaled to generate an A-AMAC identifier and utilized in association of the station and post association communications with the access point. If the A-AMAC bits are set in the AID field, the process continues to step 516 and if not the process continues to step 509 as discussed above.

At step 516, the station generates an A-AMAC identifier based on the AID and any other information exchanged between the access point and the station. For example, an A-AMAC identifier can be generated based on any pre-determined algorithm known to the access point and the station. For example, as discussed with respect to FIG. 3, any one or more octets can be used to generate the A-AMAC identifier where each octet represents a different value based on the AID, a BSSID, any other information shared or exchanged between the access point and the station, or any combination thereof.

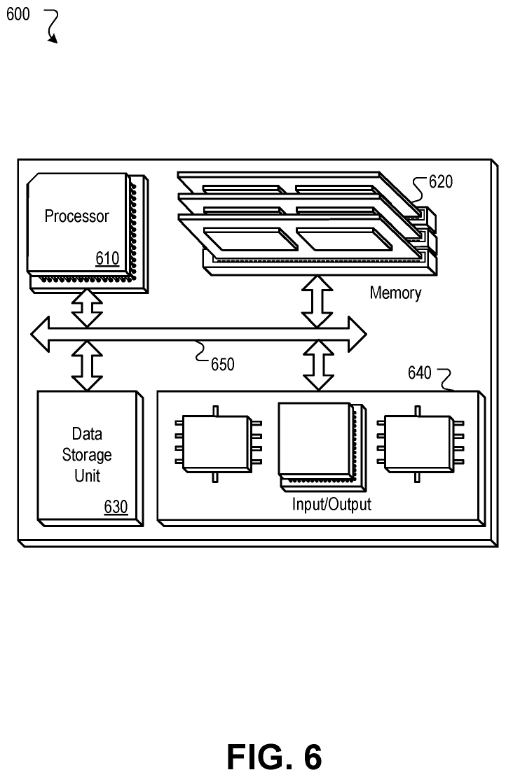

FIG. 6 is a block diagram of a hardware configuration 600 operable to facilitate management of a unique identifier, such as the A-AMAC identifier, for a station. The hardware configuration 600 can include a processor 610, a memory 620, a storage device 630, and an input/output device 640. Each of the components 610, 620, 630, and 640 can, for example, be interconnected using a system bus 650. The processor 610 can be capable of processing instructions for execution within the hardware configuration 600. In one implementation, the processor 610 can be a single-threaded processor. In another implementation, the processor 610 can be a multi-threaded processor. The processor 610 can be capable of processing instructions stored in the memory 1120 or on the storage device 630.

The memory 620 can store information within the hardware configuration 600. In one or more implementations, the memory 620 can be a computer-readable medium. In one or more implementations, the memory 620 can be a volatile memory unit. In one or more implementations, the memory 620 can be a non-volatile memory unit. In one or more implementations, the storage device 630 can be capable of providing mass storage for the hardware configuration 600. In one or more implementations, the storage device 630 can be a computer-readable medium. In one or more implementations, the storage device 630 can, for example, include a hard disk device, an optical disk device, flash memory or some other large capacity storage device. In one or more implementations, the storage device 630 can be a device external to the hardware configuration 600.

The input/output device 640 provides input/output operations for the hardware configuration 600. In one implementation, the input/output device 640 can include one or more of a network interface device (for example, an Ethernet card), a serial communication device (for example, an RS-232 port), one or more universal serial bus (USB) interfaces (for example, a universal serial bus (USB) 2.0 port), one or more wireless interface devices (for example, an IEEE 802.11 card) for outputting video, voice, and/or data services to a station 105 of FIG. 1 (for example, television, STB, computer, mobile device, tablet, telephone, wearable, etc.). In embodiments, the input/output device can include driver devices configured to send communications to, and receive communications from one or more networks (for example, local network 110 of FIG. 1, broadband access network 120 of FIG. 1, WAN 125 of FIG. 1, etc.).

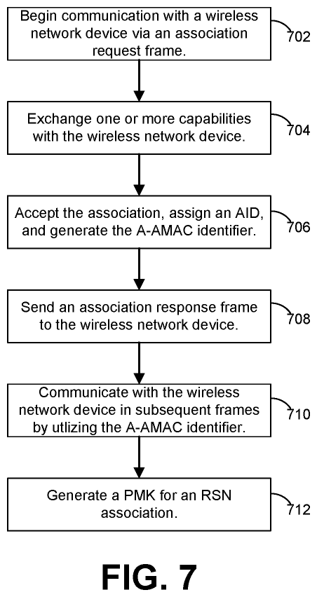

FIG. 7 is a flowchart illustrating an example process operable to facilitate an access point generating an A-AMAC identifier and exchanging capabilities information with a station, according to one or more aspects of the present disclosure. In FIG. 7, it is assumed that any one or more of the devices (such as an access point and a wireless network device) include their respective controllers and their respective software stored in their respective memories, as discussed above in connection with any of FIGS. 1-6, which when executed by their respective controllers perform the functions and operations in accordance with the example embodiments of the present disclosure (for example, including generating an A-AMAC identifier). The one or more computer-readable instructions when executed by an access point can perform any of the steps S702-S712. While the steps S702-S712 are presented in a certain order, the present disclosure contemplates that any one or more steps can be performed simultaneously, substantially simultaneously, repeatedly, in any order or not at all (omitted).

The process 700 can begins with a wireless network device (for example, station 105 of FIG. 1) requesting an association with an access point (for example, access point 115 of FIG. 1), for example, one or more capabilities exchanges can be facilitated by a A-AMAC identifier exchange module 415 of FIG. 4 and/or a A-AMAC identifier exchange module 430 of FIG. 4.

For example, at step 702, an access point begins a communication with a wireless network device via an association request frame from the wireless network device. The wireless network device can be an access point, an extender access point, a station, any other client device or wireless network device, or any combination thereof. During the association, the access point assigns an AID to the wireless network device.

At step 704, the access point can exchange one or more capabilities with the wireless network device such that the access point receives one or more capabilities from the wireless network device.

At step 706, the access point proceeds with generating the A-AMAC identifier. The generating the A-AMAC identifier comprises accepting the association with the wireless network device and assigning an AID. The access point then generates the A-AMAC identifier based on a BSSID of the access point, an AID that is assigned by the access point when the wireless network device associates with the access point, or both. As an example, the A-AMAC identifier can comprise three bytes of the BSSID, two bytes associated with the AID, and a byte associated with the BSSID with a locally administered address bit set to true. After generating the A-AMAC identifier, the access point can store the A-AMAC identifier in an association database of the access point and the A-AMAC identifier can be associated with the wireless network device in the association database. In this way, the A-AMAC identifier is unique to the access point and wireless network device.

At step 708, the access point sends an association response frame to the wireless network device. The association response frame comprises an AID. The AID includes a field that indicates to the wireless network device to generate the A-AMAC identifier based on the AID. For example, the two most significant bits of the AID field of the association response frame indicate to the wireless network device to generate and use the A-AMAC identifier based on the AID. In one or more embodiments, the A-AMAC identifier is based on the AID and any other information exchanged between the access point and the wireless network device, such as a BSSID. For example, the A-AMAC identifier can comprise three bytes associated with a lower three bytes of the BSSID, two bytes associated with the AID, and a byte associated with the BSSID with a locally administered address bit set, such as is illustrated in FIG. 3B.

At step 710, the access point communicates with the wireless network device in subsequent frames by utilizing the A-AMAC identifier. For example, the access point can utilize the A-AMAC identifier for all post association communications between the access point and the wireless network device.

At step 712, the access point generates a pairwise master key (PMK) for a robust security network (RSN) association.

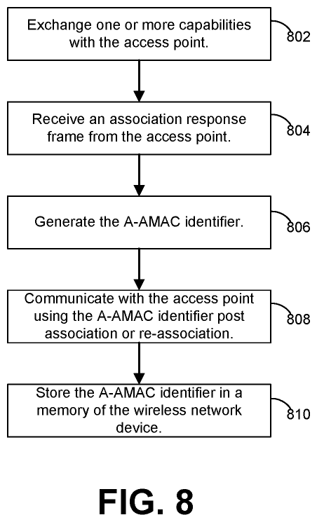

FIG. 8 is a flowchart illustrating an example process operable to facilitate a wireless network device generating an A-AMAC identifier and exchanging capabilities information with an access point, according to one or more aspects of the present disclosure. In FIG. 8, it is assumed that any one or more of the devices (such as an access point and a wireless network device) include their respective controllers and their respective software stored in their respective memories, as discussed above in connection with any of FIGS. 1-6, which when executed by their respective controllers perform the functions and operations in accordance with the example embodiments of the present disclosure (for example, including generating an A-AMAC identifier). The one or more computer-readable instructions when executed by a wireless network device can perform any of the steps S802-S810. While the steps S802-S810 are presented in a certain order, the present disclosure contemplates that any one or more steps can be performed simultaneously, substantially simultaneously, repeatedly, in any order or not at all (omitted).

The process 800 can begin after a wireless network device (for example, station 105 of FIG. 1) associates with an access point (for example, access point 115 of FIG. 1). One or more capabilities exchanges can be facilitated by a A-AMAC identifier exchange module 415 of FIG. 4 and/or a A-AMAC identifier exchange module 430 of FIG. 4.

At step 802, the wireless network device exchanges one or more capabilities with the access point. The one or more capabilities indicate support for A-AMAC identifier functionality.

At step 804, the wireless network device receives an association response frame (such as a re-association response frame) from the access point. The association response frame comprises an AID field that indicates to the wireless network device to generate the A-AMAC identifier based on an AID that is assigned by the access point when the wireless network device associates with the access point. For example, a two most significant bits of the AID field of the association response frame indicate to the wireless network device to generate the A-AMAC identifier based on the AID, a BSSID of the access point, or both. For example, the wireless network device can associate with the access point with the AID being received as part of the association. Receiving the association response frame after the association can comprise re-associating with the access point.

At step 806, the wireless network device generates the A-AMAC identifier based on the AID, the BSSID of the access point, or both. The A-AMAC identifier can also be based on other information received from the access point, such as a BSSID. For example, the A-AMAC identifier can comprise three bytes associated with a lower three bytes of the BSSID, two bytes associated with the AID, and a byte associated with the BSSID with a locally administered address bit set.

At step 808, the wireless network device can communicate with the access point using the A-AMAC identifier post association which can include post-re-association as discussed with respect to step 804.

At step 810, the wireless network device stores the A-AMAC identifier in a memory of the wireless network device.

Those skilled in the art will appreciate that the invention improves upon methods and systems for generating and utilizing unique identifiers for wireless network devices within a network so as to improve security and enhance privacy. Methods, systems, and computer readable media can be operable to facilitate generation of an A-AMAC identifier for use in post association communications between an access point and a wireless network device where the A-AMAC identifier is unique to the wireless network device and the association to the particular access point.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

1. A method for an access point to generate an association identifier association media access control (A-AMAC) identifier for communicating with a wireless network device, the method comprising:
receiving one or more capabilities from the wireless network device;
determining that the wireless network device supports A-AMAC identifier functionality based on the one or more capabilities;
generating the A-AMAC identifier based on an association identifier (AID) that is assigned by the access point when the wireless network device associates with the access point; and
sending an association response frame to the wireless network device, wherein the association response frame comprises an AID field that indicates to the wireless network device to generate the A-AMAC identifier based on the AID.

2. The method of claim 1, wherein the A-AMAC identifier is based on a basic service set identifier (BSSID) of the access point.

3. The method of claim 2, wherein the A-AMAC identifier comprises three bytes associated with a lower three bytes of the BSSID, two bytes associated with the AID, and a byte associated with the BSSID with a locally administered address bit set to true.

4. The method of claim 2, wherein a two most significant bits of the AID field of the association response frame indicate to the wireless network device to generate and use the A-AMAC identifier based on the AID and the BSSID.

5. The method of claim 1, further comprising:
communicating with the wireless network device using the A-AMAC identifier post association.

6. The method of claim 1, further comprising:
generating a pairwise master key (PMK) for a robust security network (RSN) association.

7. The method of claim 1, further comprising:
storing the A-AMAC identifier in an association database of the access point, wherein the A-AMAC identifier is associated with the wireless network device in the association database.

8. An access point for generating an association identifier association media access control (A-AMAC) identifier for communicating with a wireless network device, the access point comprising:
a memory storing one or more computer-readable instructions; and
a processor configured to execute the one or more computer-readable instructions to perform one or more operations to:
receive one or more capabilities from the wireless network device;
determine that the wireless network device supports A-AMAC identifier functionality based on the one or more capabilities;
generate the A-AMAC identifier based on an association identifier (AID) that is assigned by the access point when the wireless network device associates with the access point; and
send an association response frame to the wireless network device, wherein the association response frame comprises an AID field that indicates to the wireless network device to generate the A-AMAC identifier based on the AID.

9. The access point of claim 8, wherein the A-AMAC identifier is based on a basic service set identifier (BSSID) of the access point.

10. The access point of claim 9, wherein the A-AMAC identifier comprises three bytes associated with a lower three bytes of the BSSID, two bytes associated with the AID, and a byte associated with the BSSID with a locally administered address bit set.

11. The access point of claim 9, wherein a two most significant bits of the AID field of the association response frame indicate to the wireless network device to generate and use the A-AMAC identifier based on the AID and the BSSID.

12. The access point of claim 8, wherein the processor is further configured to execute the one or more computer-readable instructions to further perform one or more further operations to:
communicate with the wireless network device using the A-AMAC identifier post association.

13. The access point of claim 8, wherein the processor is further configured to execute the one or more computer-readable instructions to perform one or more further operations to:
generate a pairwise master key (PMK) for a robust security network (RSN) association.

14. The access point of claim 8, wherein the processor is further configured to execute the one or more computer-readable instructions to perform one or more further operations to:
store the A-AMAC identifier in an association database of the access point, wherein the A-AMAC identifier is associated with the wireless network device in the association database.

15. A non-transitory computer-readable medium of an access point storing one or more computer-readable instructions for generating an association identifier association media access control (A-AMAC) identifier for communication with a wireless network device, which when executed by a processor of the access point, cause the access point to perform one or more operations comprising:
receiving one or more capabilities from the wireless network device;
determining that the wireless network device supports A-AMAC identifier functionality based on the one or more capabilities;
generating the A-AMAC identifier based on an association identifier (AID) that is assigned by the access point when the wireless network device associates with the access point; and
sending an association response frame to the wireless network device, wherein the association response frame comprises an AID field that indicates to the wireless network device to generate the A-AMAC identifier based on the AID.

16. The non-transitory computer-readable medium of claim 15, wherein the A-AMAC identifier is based on a basic service set identifier (BSSID) access point.

17. The non-transitory computer-readable medium of claim 16, wherein the A-AMAC identifier comprises three bytes associated with a lower three bytes of the BSSID, two bytes associated with the AID, and a byte associated with the BSSID with a locally administered address bit set.

18. The non-transitory computer-readable medium of claim 16, wherein a two most significant bits of the AID field of the association response frame indicate to the wireless network device to generate and use the A-AMAC identifier based on the AID and the BSSID.

19. The non-transitory computer-readable medium of claim 15, wherein the one or more computer-readable instructions when further executed cause the access point to perform one or more further operations comprising:
communicating with the wireless network device using the A-AMAC identifier post association.

20. The non-transitory computer-readable medium of claim 15, wherein the one or more computer-readable instructions when further executed cause the access point to perform one or more further operations comprising at least one of:
generating a pairwise master key (PMK) for a robust security network (RSN) association; and
storing the A-AMAC identifier in an association database of the access point, wherein the A-AMAC identifier is associated with the wireless network device in the association database.

21-40. (canceled)
